(19) United States
(12) Patent Application Publication
(10) Pub. No.: US 2015/0114145 A1
(43) Pub. Date: Apr. 30, 2015

(54) Quick-change system for wheels of an inspection crawler

(71) Applicant: iPEK International GmbH, Sulzberg (DE)

(72) Inventor: Dominik POMP, Kempten (DE)

(21) Appl. No.: 14/519,720

(22) Filed: Oct. 21, 2014

(30) Foreign Application Priority Data
Oct. 21, 2013 (DE) 202013104734.1

(51) Int. Cl. B60B 3/14; G01M 99/00; E03F 9/00

(52) U.S. Cl. CPC B60B 3/14; E03F 9/002; G01M 99/00
USPC 73/865.8; 15/104.31; 301/35.61

(57) ABSTRACT

Quick-change system for wheels of an inspection crawler, in particular, of a pipe inspection and/or a sewage cleaning system comprising an adapter support and a wheel support (32), wherein the adapter support essentially is formed cylindrically, the wheel support has an essentially cylindrical and axial recess wherein the adapter support is arranged rotatably around a longitudinal axis of the quick-change system relative to the wheel support within the recess of the wheel support, and a locking means is arranged in the recess of the wheel support which cooperates with the wheel support and with the adapter support, and which locks the adapter support in a locked state against rotation around the longitudinal axis of the quick-change system relative to the wheel support.

### CROSS REFERENCE TO RELATED APPLICATIONS

This application claims priority under 35 U.S.C. §119 to German Application No. 20 2013 104 734.1, filed on Oct. 21, 2013, the contents of which are hereby incorporated by reference herein.

### FIELD OF THE INVENTION

The invention relates to a change system for crawler wheels of an inspection crawler, in particular, of a pipe inspection and/or sewer cleaning system, for the change of crawler wheels without tools, as well as to an inspection crawler with crawler wheels arranged at the crawler axes which comprise a change system according to the invention.

### BACKGROUND OF THE INVENTION AND PRIOR ART

For the inspection of pipes, in particular, sewers, connecting sewers or other sewer plants, usually a self propelled crawler or inspection crawler is employed. Similar crawlers or vehicles are also employed for cleaning purposes of pipes. For this, the inspection crawler or cleaning crawler comprises wheels by means of which movement within the pipe or the conduit is carried out. Depending, for example, on the pipe or conduit diameter, the inspection or cleaning crawler has to be equipped with Wheels which preferably have a set of tires adapted to the pipe or conduit diameter. For this, it is desirable to arrange the wheels including the tires releasably on the crawler axes in order to enable a changing of the wheels such that an inspection or cleaning crawler may be used in different pipes or conduits.

In prior art it is known to attach the wheels of an inspection or cleaning crawler by means of one or more screws on the crawler axis. This, however, has the disadvantage that on the one hand, tools are needed for loosening the screws, and on the other hand, the loosened screws and, where appropriate, washers may easily be lost such that downtimes of the inspection or cleaning crawler may occur. Moreover, the change of the crawler wheels takes a certain time because for each wheel, the respective screws have to be loosened and after changing the wheel have to be screwed in again. A further disadvantage is that, as far as the tools required for the changing of the wheels are not available, a changing of the wheels may not be carried out at all.

### OBJECT OF THE INVENTION

Therefore, it is an object of the present invention to provide a system by means of which the wheels of an inspection or cleaning crawler, in particular, a pipe inspection and/or sewer cleaning system may be changed faster, in a more convenient manner, safer, and without any tools.

### SOLUTION ACCORDING TO THE INVENTION

According to the invention, this object is solved according to the independent claims by a quick-change system for crawler wheels of an inspection crawler, in particular, a pipe inspection and/or sewer cleaning system, as well as an inspection crawler having wheels which comprise the quick-change system according to the invention. Preferred embodiments and developments of the invention are specified in the dependent claims.

Accordingly, a quick-change system for crawler wheels of an inspection crawler is provided for tool-less change of the crawler wheels of the inspection crawler comprising an adapter support and a wheel support wherein
the adapter support is configured substantially
the wheel support has a substantially cylindrical and axial recess wherein the adapter support is arranged rotatably around a longitudinal axis of the quick-change system with respect to the wheel support in the recess of the wheel support, and
a locking means is arranged within the recess of the wheel support which cooperates with the wheel support and with the adapter support, and which locks the adapter support in a locked state against rotation about the longitudinal axis of the quick-change system with respect to the wheel support.

The locking means may comprise a locking cross and at least one spring member wherein
a first recess corresponding to the locking cross is provided in the bottom face of the recess of the wheel support with which the locking cross in a locked state of the locking means can partially be brought into engagement,
a second recess corresponding to the locking cross is provided in the bottom face of the adapter support with which the locking cross in a non-locked state of the locking means can completely be brought into engagement, and
the at least one spring member is arranged in the second recess wherein the spring member pushes the locking cross in a locked state of the locking means partially out of the second recess such that the locking cross in the locked state of the locking means engages with the first recess as well as with the second recess.

Further, the locking means may comprise a pressure pin which is arranged in an axial boring in the bottom of the recess of the wheel support, and which cooperates with the locking cross wherein a movement of the pressure pin against the locking cross effects a movement of the locking cross against the spring force of the spring member such that the locking cross may be pushed out of the recess in the bottom face of the wheel support completely, and the locking means may be brought into a non-locked state.

The locking cross may have a cross profile with three profile legs being arranged in an angle of 120^{°} with respect to each other wherein the at least one spring member comprises three compression springs wherein each one of the compression springs is arranged at least partially within the axial boring in the second recess such that respectively one compression spring exerts a spring force against a respective profile leg.

The quick-change system further may comprise a lock washer which at least partially covers the recess of the wheel support wherein the lock washer has a hole coaxial with respect to the recess of the wheel support the diameter of which being smaller than the inner diameter of the recess of the wheel support and smaller than the exterior diameter of the adapter support.

The lock washer may be attachable to the wheel support by means of fixation means, preferably screws, and in a fixed state may prevent to a great extent an axial movement of the adapter support being arranged within the recess of the wheel support relative to the wheel support.

Thereby, the adapter support may only be rotated about the longitudinal axis of the quick-change system. An axial movement of the adapter support relative to the wheel support or relative to the quick-change system no longer is possible.

The adapter support may have a third recess which is provided at the opposing bottom face with the second recess for receiving an axis end portion and/or the axis adapter wherein the third recess has a cross section which prevents a rotation of the axis end portion arranged in the third recess and/or the axis adapter about the longitudinal axis of the quick-change system.

The third recess of the adapter support and the axis end portion and/or the axis adapter may have an identical cross section.

The third recess of the adapter support preferably has a side wall with three plane portions being arranged in an angle of 60° with respect to each other.

Preferably, respectively two plane portions of the side wall are connected to each other via a curved portion with a predetermined radius.

The adapter support may have a number of radial penetrations which respectively lead to the third recess in the adapter support.

The radial penetrations preferably comprise three radial bore holes which in a circumferential direction are equally spaced from each other.

Preferably, the radial penetrations are arranged in the circumferential direction of the adapter support such that the outlets of the penetrations respectively are located in the region of a plane portion of the side wall of the third recess of the adapter support.

According to a preferred embodiment of the invention, the adapter support has locking members which cooperate with an axis end portion or axis adapter arranged within the third recess of the adapter support which are movable between a locking position and a release position, and which in the locking position prevent an axial movement of the axis end portion or axis adapter arranged in the third recess of the adapter support relative to the adapter support.

Preferably, the locking members are arranged in the radial penetrations of the adapter support, and are movable axially inwards into the locking position.

The locking members may at least partially protrude from the respective outlets of the penetrations and engage with corresponding recesses which are arranged in the circumferential direction of the axis end portion or axis adapter. Thereby, the quick-change system according to the invention is axially locked at the axis end portion or at the axis adapter.

The locking members may be configured spherically or pin-shaped.

According to a preferred embodiment of the invention, in each penetration of the adapter support, at least two spherical locking members are arranged.

A number of equally spaced sliding block recesses may be provided in the side wall of the cylindrical recess of the wheel support wherein the depth of the sliding block recesses increases in circumferential direction.

In a preferred embodiment of the invention, three sliding block recesses are provided wherein the locking members arranged in the radial penetrations of the adapter support at least partially protrude into the sliding block recesses.

During rotation of the adapter support about the longitudinal axis of the quick-change system relative to the wheel support and
towards lower depths of the sliding block recesses, the sliding block recesses effect a movement of the locking members into the locking position, and
towards greater depths of the sliding block recesses, the locking members may be brought into a release position.

In an embodiment of the invention, the quick-change system further comprises an axis adapter which is attachable to an axis end portion of a crawler axis of an inspection crawler, in particular, releaseably attachable, and which has the same cross sectional profile as the third recess in the adapter support. Thereby, already existing crawler axes or end portions of the crawler axis may be augmented or upgraded in order to enable a quick and, in particular, tool-less change of wheels having a quick-change system according to the invention.

The axis adapter in circumferential direction preferably has recesses spaced apart from each other which engage with the locking members in their locking position. These recesses may be configured in a spherical cup shape or trough-shaped.

Preferably, the single components of the quick-change system according to the invention comprise metal or stable plastics.

Further, an inspection crawler, in particular, of a pipe inspection and/or sewer cleaning system, is provided comprising at least one crawler axis on which the crawler wheels are arranged which comprise the quick-change system according to the invention.

In particular, the invention provides the advantage that wheels or crawler wheels may be mounted, dismantled or changed without any tools enabling a particularly quick and simple change of wheels. Because the loosening of the screw connections for taking off the crawler wheels is omitted, and because the crawler wheel to be mounted only has to be fitted ono the crawler axis and locked by rotation, a wheel change can be accomplished substantially faster than with crawler wheels known from prior art.

Because no screws or other releasable parts are present at the quick-change system, these may also not be lost such that down times may be substantially reduced.

### BRIEF DESCRIPTION OF THE DRAWINGS

Further details and features of the invention as well as concrete, in particular, preferred embodiments of the invention may be derived from the following description in connection with the drawings in which

FIG. 1 shows an inspection or cleaning crawler with three crawler axes for illustrating the basic principle of the quick-change system according to the invention.

FIG. 2 shows two perspective views of an axis adapter of the quick-change system according to the invention,

FIG. 3 shows a quick-change system according to the invention in a front view,

FIG. 4 shows a cross sectional view along the section axis A-A of the quick-change system according to the invention,

FIG. 5 shows a sectional view of a quick-change system according to the invention along the section axis D-D;

FIG. 6 shows a sectional view of the quick-change system according to the invention along the section axis C-C; and

FIG. 7 shows two perspective views of a quick-change system according to the invention.

### DETAILED DESCRIPTION OF THE FIGURES

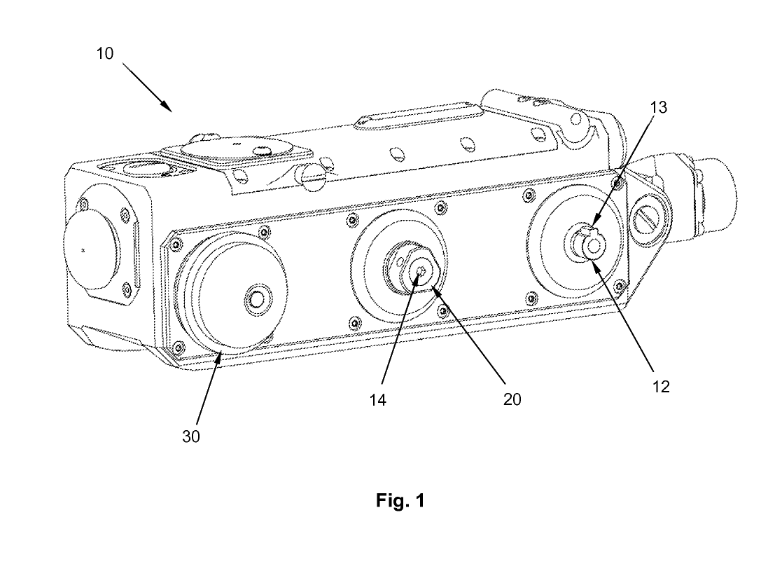

FIG. 1 shows an example of an inspection or cleaning crawler 10 which, for example, may be configured as camera crawler for inspection of pipes or conduits. In the illustration shown in FIG. 1 of the inspection or cleaning crawler, only the elements essential for the invention are shown. The inspection or cleaning crawler may comprise further structures or extensions.

The inspection or cleaning crawler shown in FIG. 1 has three wheel or crawler axes 12. Of course, an inspection or cleaning crawler may also have more than three or less than three crawler axes 12.

At the free end, the substantially cylindrical crawler axis 12 has a radial pin 13 which serves as locking means for an axis adapter 20 fitted on the crawler axis 12. The axis end portion of the crawler axis 12 may, however, also have a rectangular or square cross section such that a locking means of a superimposed axis adapter 20 is already implemented due to the geometry of the axis end portion such that the radial pin 13 shown here may just as well be omitted.

In the example shown in FIG. 1, an axis adapter 20 is arranged at the middle wheel axis and is fixedly connected to the crawler axis 12 by means of a screw 14. The wheel which comprises the quick-change system according to the invention is pushed onto the axis adapter 20, and is locked axially by rotation. Due to the geometry of the adapter 20, moreover, it is ensured that the mounted wheel or the mounted quick-change system cannot rotate with respect to the axis adapter 20 about the longitudinal axis of the crawler axis.

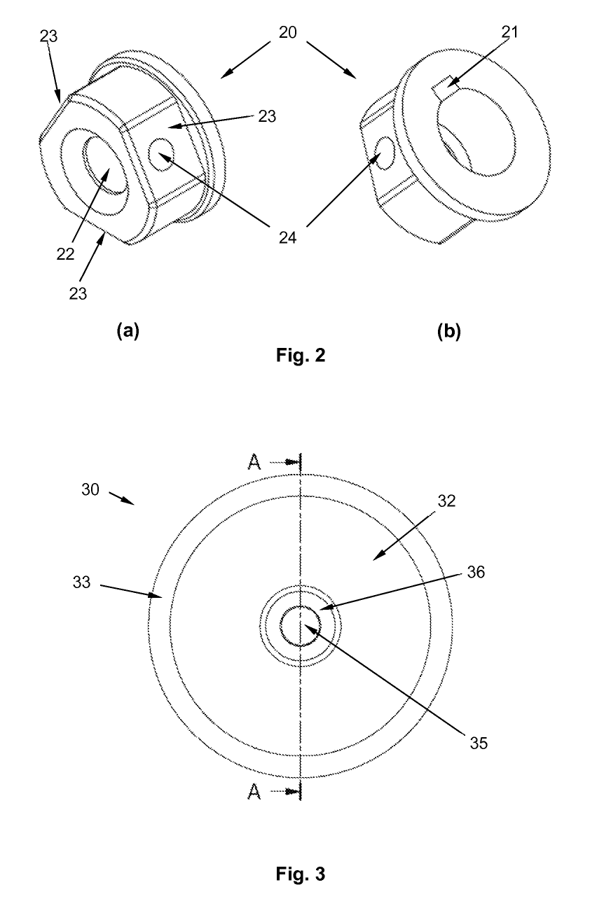

A detailed view of the axis adapter 20 is described in further detail with respect to FIG. 2.

Instead of an axis adapter 20, the axis end portion of the crawler axis may also have the same geometry and dimensions as the axis adapter 20 such that a wheel with the quick-change system according to the invention may be mounted onto the crawler axis directly. An axis adapter 20 which is attached to the end portion of the crawler axis 12, however, has the advantage that also inspection or cleaning crawlers with common crawler axes may be augmented or upgraded in order to receive wheels of a quick-change system according to the invention.

In FIG. 1, a quick-change system according to the invention (without a set of tires) of a wheel is shown. The assembly and functioning of the quick-change system 30 according to the invention are described in further detail with reference to FIG. 3 to FIG. 7.

FIG. 2 shows two illustrations of an axis adapter 20 of the quick-change system according to the invention in perspective view from the front (a) and from the rear (b) sides.

At the rear side, the axis adapter has a cylindrical recess the diameter of which basically corresponds to the diameter of the end portion of the crawler axis. The crawler axis or the end portion of the crawler axis is received in this recess. Further, the side wall of this recess has a radial recess 21 which corresponds to the pin 13 of the crawler axis shown in FIG. 1. In a mounted state of the axis adapter 20, the radial pin 13 of the crawler axis engages into the radial recess 21 such that rotation of the axis adapter 20 about the longitudinal axis of the crawler axis relative to the crawler axis is prevented.

At the outer wall of the axis adapter 20, recesses 24 equally spaced apart from each other are provided in circumferential direction into which the locking members of the quick-change system may engage axially. The recesses 24 preferably are configured in a spherical cap like shape or trough-shaped such that a release procedure or a release of the quick-change system from the axis adapter 20 may be effected with little effort.

In the embodiment shown here, the side wall of the axis adapter 20 has three plane portions 23 which are set in an angle of 60° with respect to each other. However, two plane portions 23 are connected to each other via a curved portion which has a predetermined radius. Due to this geometry it is prevented that a quick-change system according to the invention fitted on the axis adapter 20 may rotate about the longitudinal axis of the crawler axis relative to the axis adapter. Of course, the axis adapter 20 may also have another geometry, for example, a square cross section which prevents rotation of the quick-change system about the longitudinal axis of the crawler axis relative to the axis adapter.

Further, the axis adapter 20 has an axial bore hole 22 which is provided for receiving a screw by means of which the axis adapter can be fixed at the end portion of the crawler axis. Preferably, the bore hole 22 is configured in an embedded manner such that the fixation screw does not project beyond the axis adapter.

FIG. 3 shows a quick-change system 30 according to the invention in a front view, i.e., from the side facing away from the crawler axis.

In FIG. 3, the lock washer 33, the wheel support 32, and the pressure pin 35 of the quick-change system 30 according to the invention are visible. The pressure pin 35 is arranged within a bore hole which preferably is configured in an embedded manner such that the pressure pin in a locked state of the quick-change system does not project beyond the wheel support 32. The counterbore 36 of the bore hole preferably has an external diameter which enables a simple manipulation of the pressure pin 35 with a finger.

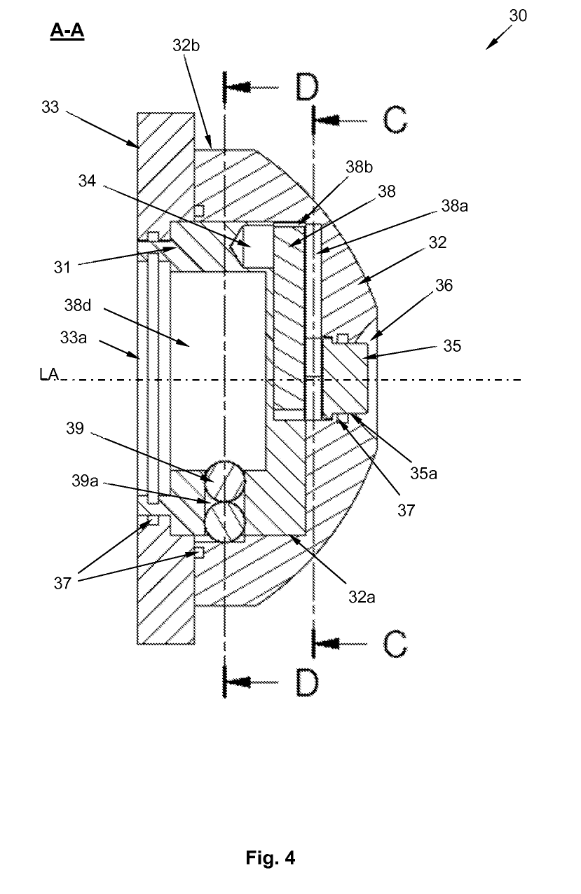

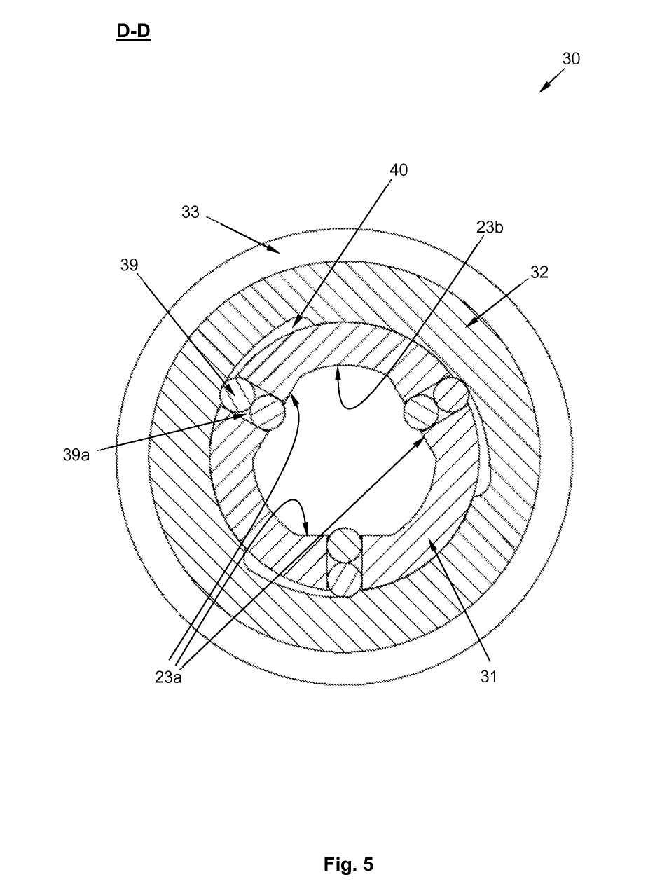

FIG. 4 shows a sectional view of a quick-change system 30 according to the invention along the sectional axis A-A.

The quick-change system according to the invention basically comprises a wheel support 32, an adapter support 31, and a lock washer 33 as well as a locking means and locking members.

The wheel support 32 has an external shape which basically corresponds to a spherical cap. The spherical cap shaped portion of the wheel support 32 changes over into a cylindrical portion 32b which forms a circumferential support plane for receiving a wheel.

The wheel support 32 has an axial bore hole 35a which is provided for receiving a pressure pin 35. The pressure pin 35 has at the end facing the crawler axis a larger diameter than the bore hole 35a such that a removal or dropping of the pressure pin 35 from the bore hole 35a is prevented efficiently. A circumferential sealing ring 37 may be provided in the bore hole 35a which prevents the entry of liquid or dirt into the interior of the quick-change system.

The wheel support 32 at the side facing the crawler axis has a cylindrical and axial recess 32a for receiving the adapter support 31. The external diameter of the adapter support 31 basically corresponds to the internal diameter of the recess 32a of the wheel support 32. The external diameter of the adapter support 31 and/or the internal diameter of the recess 32a of the wheel support 32 are adapted such that the adapter support 31 may be rotated in the recess 32a about the longitudinal axis LA of the quick-change system relative to the wheel support 32.

The rotation of the adapter support relative to the wheel support is necessary in order to lock an axis adapter received in the adapter support, as will be described in further detail below.

A locking means is provided in the recess 32a of the wheel support 32 which cooperates with the wheel support 32 and with the adapter support 31 arranged within the recess 32a. The locking means ensures that with a quick-change system mounted, the adapter support 31 may not be rotated with respect to the wheel support 32.

Here, the locking means comprises a locking cross 38, spring members, and the pressure pin 35. A recess 38a is provided in the bottom of the recess 32.a of the wheel support 32 with which the locking cross 38 at least partially may be brought into engagement. Further, also the surface of the adapter support 31 facing the bottom of the recess 32a has a recess 38b with which the locking cross also may be brought into engagement. The recess 38b in the adapter support 31, however, is dimensioned such that the locking cross 38 completely may be accommodated within it in order to release the quick-lock system such that the wheel support 32 may be rotated with respect to the adapter support 31.

In a locked state of the locking means, the locking cross partially engages into the recess 38a as well as also partially into the recess 38b preventing a mutual twisting of the adapter support and the wheel support.

The pressure pin 35 is provided in order to push the locking cross out of the recess 38a and completely into the recess 38b, and to thereby release the locking of the quick-change system.

In case the pressure pin 35 is released, the spring members cause the locking cross 38 to again engage with the recess 38a as far as the recess 38a and the recess 38b are superimposed. For arrangement of the spring members, radial blind holes 34 are provided in the adapter support 31. By pushing the pressure pin 35, the locking cross is pressed out of the recess 38 against the spring force of the spring members arranged in the bore holes. Preferably, pressure springs are used as spring members.

The locking means or locking mechanism shown in FIG. 4 may also be arranged in a mirror inverted manner. I.e., the locking of the quick-change system is released in that the pressure pin 35 is pulled out of the bore hole 35a, and thereby, the locking cross 38 is completely received in the recess 38a of the wheel support 32. Accordingly, then there are provided axial blind holes in the wheel support 32 in which the spring members are accommodated, and which upon releasing the pressure pin 35 cause the locking cross 38 to at least partially be pushed into the recess 38b and thereby lock the quick-change system as long as the recess 38a and the recess 38b are superimposed.

A concrete configuration of a lock ng cross 38 according to the invention is shown with reference to FIG. 6.

In both variants of the configuration of the locking means, the pressure pin 35 may be fixedly connected to the locking cross or may be designed in one piece.

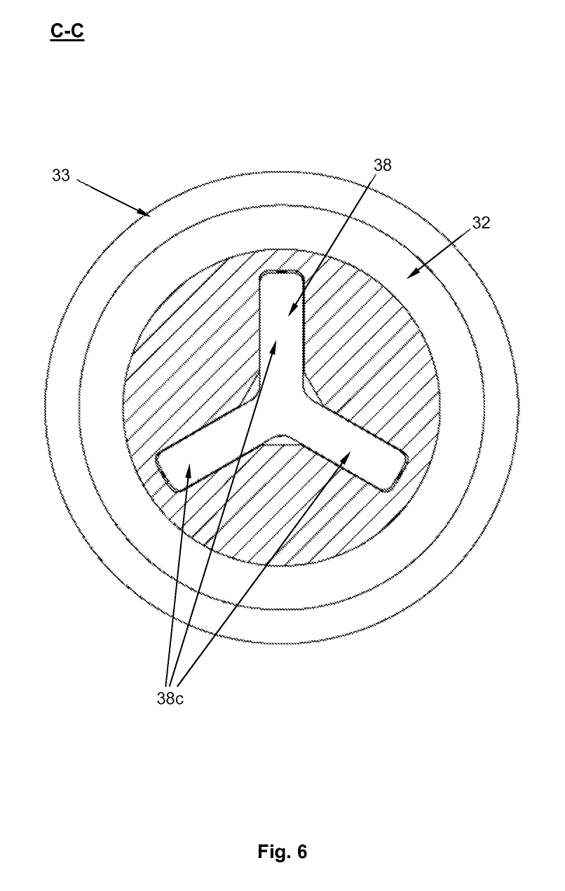

The adapter support 31 basically is formed cylindrically. At the side facing the crawler axis, the adapter support 31 has a recess 38d in which the axis adapter 20 or an axis end portion of a crawler axis is arranged. The exact geometry of the 7.0 recess 38d of the adapter support will be described in further detail with reference to FIG. 5.

The adapter support 31 has radial penetrations 39a at the side walls which respectively lead into the recess 38d. In the embodiment shown here, the radial penetrations 39a are configured as radial bore holes which are equally spaced apart in circumferential direction of the adapter support. In the embodiment shown here, the adapter support 31 has three radial bore holes 39a. However, also more than three or less than three radial bore holes 39a may be provided.

In the radial penetrations or radial bore holes 39a, locking members 39 are arranged which here may be configured spherically. In the embodiment of the quick-lock system according to the invention shown in FIG. 4, respectively two spherical locking members 39 are arranged in the radial bore holes 39a. In the locked state of the quick-change system, the locking members 39 partially project from the opening 39a in radial direction, and engage with corresponding recesses 24 of the axis adapter 20 or the axis end portion of a crawler axis (cf. FIG. 2).

In the released state or during releasing of the quick-change system, the locking members are pushed into the respective radial bore holes 39a as far as the axis adapter or the axis end portion of the crawler axis are able to be pulled out of the recess 38d in axial direction. The principle of locking by means of locking members 39 will be described in further detail with reference to FIG. 5.

On the side of the wheel support 32 facing the crawler axis, a lock washer 33 is arranged which has an axial hole 33a through which the axis adapter 20 or an axis end portion of the crawler axis is insertable. Further, the diameter of the hole 33a of the lock washer 33 is smaller than the external diameter of the adapter support 31 such that the lock washer 33 of the adapter support 31 is fixedly held within the recess 32a of the wheel support 32, and a displacement of the adapter support 31 in radial direction relative to the wheel support 32 is prevented.

The lock washer 33 may be fixed to the wheel support 32 by means of screw connections which are not shown here. Also with a lock washer 33 fixed or mounted, the adapter support 31 can be rotated about the longitudinal axis LA with respect to the wheel support 32 as far as the locking means is in a non-locked state.

Between the lock washer 33 and the wheel support 32 and/or between the lock washer 33 and the adapter support 31, circumferential sealing rings 37 may be provided which prevent an entry of dirt or liquid into the interior of the quick-change system.

FIG. 5 shows the quick-change system 50 according to the invention in cross sectional view along the section axis D-D.

Here, it can be seen that the lock washer 33 has a larger external diameter than the wheel support 32. In an embodiment of the invention, these two diameters may, however, also be selected so as to be identical.

The side wall of the recess 32a of the wheel support 32 has a number of sliding block recesses 40 equally spaced apart in circumferential direction which are open at the side of the wheel support facing the crawler axis. Hereby, it is important that the depth of the sliding block recesses 34 increases in circumferential direction such that during rotation of the wheel support 32 with respect to the adapter support 31, the locking members 39 can be pushed radially inwards or radially outwards.

In the example shown in FIG. 5, the spherical locking members 39 are pushed radially inwards during a right hand rotation of the wheel support such that the radially inner sphere at least partially projects from the bore hole 39a, and can be brought into engagement with the recess 24 shown in FIG. 2.

During a left hand rotation, the distance between the external wall of the adapter support 31 and the side wall of the sliding block recess 40 grows increasingly larger such that the spherical locking members 39 can be pushed radially outwards at least as far as the radially inner sphere is able to be pushed out of the recess 24. For example, this may result from a slight pulling of the quick-change system in axial direction from the axis adapter.

The inner wall of the recess 38d of the adapter support 31 in the embodiment shown here has three substantially plane portions 23a which are set in an angle of 60° with respect to each other, and wherein respectively two plane portions 23a are connected to each other via a curved portion 23b wherein the curved portion 23b has a predetermined radius. The axis adapter 20 and the recess 38d of the adapter support basically have the same profile such that a twisting of the adapter support with respect to the axis adapter is prevented.

In an alternative embodiment of the invention, the recess 38d may, for example, also have a square cross section, i.e., may basically have four plane side wall portions which are set in an angle of 90° with respect to each other. Accordingly, also four radial penetrations 39a may be provided in which the locking members are arranged. Corresponding to the four radial penetrations 39a, accordingly also four sliding block recesses 40 are to be provided. Moreover, also the shape of the axis adapter 20 is to be adapted accordingly.

FIG. 6 shows a sectional view of a quick-change system according to the invention along the sectional axis C-C.

In FIG. 6 specifically the configuration of the locking cross 38 can be seen which here has three profile legs 38 arranged in an angle of 120° with respect to each other. The recess 38a in the Wheel support 32 and the recess 38b in the adapter support 31 for receiving the locking cross have the same profile as the locking cross itself. Further, preferably three spring members are provided in the recess 38a of the wheel support or in the recess 38b of the adapter support wherein the spring members are arranged such that each profile leg 38c is assigned to a spring member.

In an embodiment not shown here, the locking cross 38 may also have more legs. For example, a cross profile with four profile legs may be provided. In a further embodiment, also a locking plate or a locking rod with rectangular or square cross section may be provided instead of the locking cross.

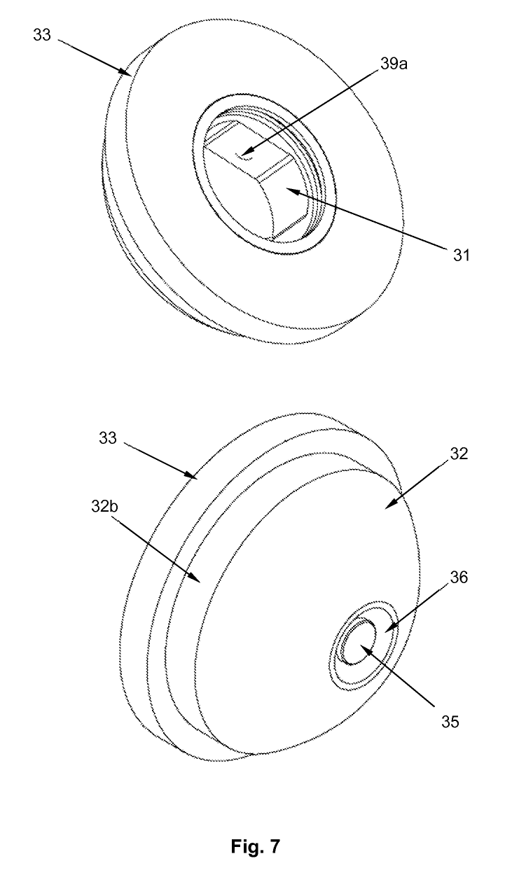

FIG. 7 shows a quick lock system 30 according to the invention in perspective view. Here, the pressure pin 35 can be particularly seen in the trough 36 of the bore hole 35a in a locked state of the quick-change system wherein the pressure pin 35 does not project beyond the quick-change system. Also, the circumferential support plane 32b for receiving a wheel is clearly visible. The depth of the circumferential support plane 32b may be selected according to the wheel to be used.

The quick-change system described above allows for a particularly simple, quick, and specifically tool-less change of wheels of an inspection crawler or cleaning crawler of a pipe inspection and/or sewer cleaning system.

For mounting a wheel by means of the quick-change system according to the invention, the adapter support 31 is fitted on the axis adapter 20, and is blocked by means of rotation and at the same time is locked. For removal of a wheel, only the pressure pin 35 is pushed (or pulled out) in order to release the locking cross. After release of the locking cross, the quick-change system is rotated in the reverse direction such that the locking members of the quick-change system or the quick-change system can be released. After the release of the quick-change system, the wheel can be pulled from the axis adapter 20 or from the end portion of a crawler axis.

### LIST OF REFERENCE NUMERALS

10 crawler or inspection crawler
12 wheel or crawler axis
13 radial pin at the crawler axis
14 screw
20 axis adapter
21 radial recess (corresponding to the pin 13)
22 bore hole for receiving the screw 14
23 flattened portions of the axis adapter
23a plane portions of the side wall of the third recess 38d
23h curved connection portion between two plane portions 23a
24 recesses (spherical or through shaped)
30 quick-change system
31 adapter support
32 wheel support
32a cylindrical recess of the wheel support 32 for receiving the adapter support 31
32b circumferential support plane for receiving a wheel
33 lock washer
33a axial hole in the lock washer
34 bore hole for receiving a spring member of the locking means
35 pressure pin of the locking means
35a bore hole for receiving the pressure pin
36 indentation
37 sealing ring
38 locking cross of the locking means
38a first recess in the wheel support for receiving the locking cross
38b second recess in the adapter support for receiving the locking cross
38c leg or profile leg of the locking cross
38d third recess in the adapter support for receiving the axis adapter 20
39 locking members (e.g., balls)
39a radial penetrations (e.g., bore holes) in the adapter support 31
40 sliding block recesses in the side wall of the cylindrical recess 32a
LA longitudinal axis of the quick-change system

1. A quick-change system (30) for wheels of an inspection crawler (10), in particular, of a pipe inspection or a sewage cleaning system comprising an adapter support (31) and a wheel support (32), wherein
the adapter support essentially is formed cylindrically,
the wheel support has an essentially cylindrical and axial recess (32a) wherein the adapter support is arranged rotatably around a longitudinal axis (LA) of the quick-change system relative to the wheel support within the recess (32a) of the wheel support, and
a locking means is arranged in the recess (32a) of the wheel support which cooperates with the wheel support and with the adapter support, and which locks the adapter support in a locked state against rotation around the longitudinal axis (LA) of the quick-change system relative to the wheel support.

2. The quick-change system of claim 1, wherein the locking means comprises a locking cross (38) and at least one spring member, wherein
a recess (38a) is provided in the bottom face of the recess (32a) of the wheel support (32) corresponding to the locking cross into which the locking cross in a locked state of the locking means can be brought into engagement at least partially,
a second recess (38b) is provided in the base face of the adapter support (31) corresponding to the locking cross (38b) into which the locking cross in anon-locked state of the locking means can be brought into engagement completely,
a spring member is arranged in the second recess (38b) wherein the spring member pushes the locking cross in a locked state of the locking means at least partially out of the second recess (38b) and into the first recess (38a) such that the locking cross in a locked state of the locking means engages with the first recess (38a) as well as with the second recess (38b).

3. The quick-change system of claim 2, wherein the locking means further comprises a pressure pin (35) which is arranged in an axial bore hole (35b) in the bottom of the recess (32a) of the wheel support (32), and with which the locking cross cooperates wherein a movement of the pressure pin against the locking cross effects a movement of the locking cross against the spring force of the spring member such that the locking means can be completely pushed out of the first recess (38a) in the bottom face of the wheel support (32) and the locking means can be brought into a non-locked state.

4. The quick-change system of claim 2, wherein the locking cross (38) comprises a cross profile with three profile legs (38c) being arranged in an angle of 120° with respect to each other, and wherein the at least one spring member comprises three pressure springs wherein each of the pressure springs is arranged in an axial bore hole (34) in the second recess (38b) at least partially such that respectively one pressure spring exerts a spring force against a respective profile leg.

5. The quick-change system of claim 1, further comprising a lock washer (33) covering the recess (32a) of the wheel support (32) at least partially wherein the lock washer has a hole (33a) being coaxial with respect to the recess (32a) of the wheel support (32), the diameter of which is smaller than the interior diameter of the recess (32a) of the wheel support (32) and smaller than the exterior diameter of the adapter support (31).

6. The quick-change system of claim 5, wherein the lock washer (33) is attachable to the wheel support (32) by means of fixation means, preferably screws, and substantially prevents in a fixed state, an axial movement of the adapter support arranged in the recess (32a) of wheel support (32) relative to the wheel support.

7. The quick-change system of claim 1, wherein the adapter support (31) comprises a third recess (38d) at the opposing base face comprising the second recess (38b) for receiving an axis end portion and/or an axis adapter (20) wherein the third recess (38d) has a cross section which prevents rotation of the axis end portion and/or axis adapter arranged in the third recess (38d) about the longitudinal axis (LA) of the quick-change system.

8. The quick-change system of claim 7, wherein the third recess (38d) of the adapter support (31) and the axis end portion and/or the axis adapter (20) have an identical cross section.

9. The quick-change system of claim 7, wherein the third recess (38d) of the adapter support (31) has a side wall with three plane portions (23a) being arranged substantially in an angle of 60° with respect to each other.

10. The quick-change system of claim 9, wherein respectively two plane portions (23a) of the side wall are connected via a curved portion (23b) having a predetermined radius.

11. The quick-change system of claim 1, wherein the adapter support (31) has a number of radial penetrations (39a) which respectively lead into the third recess (38d) of the adapter support (31).

12. The quick-change system of claim 11, wherein the radial penetrations (39a) comprise three radial bore holes (39a) which are equally spaced apart in a circumferential direction of the adapter support (31).

13. The quick-change system of claim 11, wherein the radial penetrations (39a) in the circumferential direction of the adapter support (31) are arranged such that the outlets of the penetrations (39a) respectively are located within the region of a plane portion (23a) of the side wall of the third recess (38d) of the adapter support (31).

14. The quick-change system of claim 1, wherein the adapter support (31) comprises locking members (39) which cooperate with an axis end portion or axis adapter (20) arranged in the third recess (38d) of the adapter support (31) which are movable between a lock position and a release position, and which prevent an axial movement of the axis end portion or axis adapter (20) arranged within the third recess (38d) of the adapter support (31) relative to the adapter support.

15. The quick-change system of claim 14, wherein the locking members (39) are arranged in the radial penetrations (39a) of the adapter support (31) and which are movable axially inwards into the locking position.

16. The quick-change system of claim 14, wherein the locking members (39) in the locking position at least partially project from the respective outlets of the penetrations (39a), and engage with corresponding recesses (24) which are arranged in circumferential direction of the axis end portion or axis adapter (20).

17. The quick-change system of claim 14, wherein the locking members (39) are configured spherically or pin-shaped.

18. The quick-change system of claim 17, wherein at least two spherical locking members (39) are arranged in each penetration (39a) of the adapter support (31).

19. The quick-change system of claim 1, wherein a number of sliding block recesses (40) being equally spaced apart in circumferential direction is provided in the side wall of the cylindrical recess (32a) of the wheel support (32), wherein the depth of the sliding block recesses increases in circumferential direction.

20. The quick-change system of claim 19, wherein three sliding block recesses (40) are provided, and wherein the locking members (39) arranged in the radial penetrations (39a) of the adapter support (31) at least partially project into the sliding block recesses (40).

21. The quick-change system of claim 20, wherein during rotation of the adapter support (31) about the longitudinal axis (LA) of the quick change system relative to the wheel support (32), and
towards lower depth of the sliding block recesses (40), the sliding block recesses cause a movement of the locking members (39) into the locking position, and
towards greater depths of the sliding block recesses (40), the locking members (39) can be brought into a release position.

22. The quick-change system of claim 1, further comprising an axis adapter (20) which is attachable to an axis end portion of a crawler axis of an inspection crawler, in particular, releasably attachable, and which has the same cross sectional profile as the third recess (38d) in the adapter support (31).

23. The quick-change system of claim 22, wherein the axis adapter (20) in circumferential direction has recesses (24) spaced apart from each other which engage with the locking members (39) in the locking position.

24. The quick-change system of claim 1, wherein the single components (20; 31; 32; 33; 35; 38; 39) comprise a metal or a stable plastics material.

25. An inspection crawler (10), in particular of a pipe inspection or sewage cleaning system, comprising at least one crawler axis on which the crawler wheels are arranged which comprise the quick-change system (30) of claim 1.
